(19) United States
(12) Patent Application Publication
(10) Pub. No.: US 2024/0428019 A1
(43) Pub. Date: Dec. 26, 2024

(54) METHOD AND APPARATUS FOR GENERATING CONTENT USING USER SENTENCES

(71) Applicant: FAMPPY INC., Anyang-si Gyeonggi-do (KR)

(72) Inventors: Hae Jin PARK, Guro-gu Seoul (KR); Sang Yong Lee, Guro-gu Seoul (KR); Gun Young Lee, Gwank-gu Seoul (KR); Hyo Yeon Kim, Gyeonggi-do (KR)

(73) Assignee: FAMPPY INC, Anyang-si Gyeonggi-so (KR)

(21) Appl. No.: 18/218,847

(22) Filed: Jul. 6, 2023

(30) Foreign Application Priority Data
Jun. 22, 2023 (KR) 10-2023-0080604

(51) Int. Cl. G06F 40/56; G06F 40/58

(52) U.S. Cl. CPC G06F 40/56; G06F 40/58

(57) ABSTRACT

A method of recommending, by a recommendation apparatus, an asset and content to a user, and including receiving learning data from a platform for using the content and an authorizing tool for producing the content; constructing a learning model based on the training data; generating 1/a first model for analyzing characteristics of the user, 2) a second model for recommending the content, and 3) a third model for recommending the element using the learning model; transferring recommended content information to the platform using the first model and the second model; and transferring recommended element information to the authorizing tool.

### TECHNICAL FIELD

The present specification relates to a method for generating content using user sentences using artificial intelligence.

### BACKGROUND ART

There may be several approaches that utilize artificial intelligence in producing experiential content. For example, there may be an interactive storytelling technology in which users become main characters of a specific story, a method of developing a virtual character that interacts with the user in an environment such as virtual reality or augmented reality, or the like.

A combination of various technologies and tools is required to produce completed experiential content in which users directly participate using artificial intelligence. For example, natural language processing technologies and machine learning algorithms may be used to construct systems that understand user input and generate content accordingly.

To this end, it is necessary to further develop artificial intelligence models to meet complex interactions and various user needs, and to construct systems that process users' actions and responses in real time and provide results accordingly.

In addition, development is required in a direction of providing a personalized experience by collecting user preferences or feedback in a process of producing content according to user needs.

### DISCLOSURE

### Technical Problem

An object of the present specification is to generate information necessary for an asset search capable of generating content through artificial intelligence using sentences written by a user.

In addition, an object of the present specification is to generate content using sentences written by a user through artificial intelligence.

Objects of the present specification are not limited to the above-mentioned objects. That is, other objects that are not mentioned may be obviously understood by those skilled in the art to which the present specification pertains from the following detailed description.

### Technical Solution

According to an embodiment of the present invention, a method of generating, by a recommendation apparatus, content to a user and recommending an asset to be displayed in the content, the method comprising: receiving a sentence for generating the content from a user; transforming the sentence into a story type text through a language model; transforming the story type text into a storyline including 1) a background, 2) a main character, and 3) a main element through the language model; transforming the storyline into sentence data for generating the content or recommending the asset through the language model; and generating the content or recommending the asset based on the sentence data.

The method may further include: transforming the sentence into English; and transforming the storyline into Hangul.

The sentence data may include a source word, an English word corresponding to the source word, parts of speech, and importance.

The story type text may be transformed through the language model based on a command for writing a synopsis.

The method may further include: extracting a keyword by analyzing an element file including element information; transforming the keyword into the story type text through the language model; and updating meta information of the asset based on the sentence data.

The method may include the meta information of the asset is used to search for the asset.

According to another embodiment of the present invention, a recommendation apparatus for recommending an asset and content to a user include a communication unit, a memory including a language model, and a processor configured to functionally control the communication unit and the memory, in which the processor receives a sentence for generating the content from a user, transforms the sentence into a story type text through a language model, transforms the story type text into a storyline including 1) a background, 2) a main character, and 3) a main element through the language model, transforms the storyline into sentence data for generating the content or recommending the asset through the language model, and generates the content or recommending the asset based on the sentence data.

### Advantageous Effects

According to an embodiment of the present specification, it is possible to generate information necessary for an asset search capable of generating content through artificial intelligence using sentences written by a user.

In addition, according to an embodiment of the present specification, it is possible to generate content using sentences written by a user through artificial intelligence.

Effects which can be achieved by the present specification are not limited to the above-mentioned effects. That is, other objects that are not mentioned may be obviously understood by those skilled in the art to which the present specification pertains from the following description.

### DESCRIPTION OF DRAWINGS

FIG. 1 is a block diagram for describing an electronic device related to this specification.

FIG. 2 is an embodiment to which this specification may be applied.

FIG. 3 is an example of the generation of a page to which this specification may be applied.

FIG. 4 is an example of a controller 400 which may be applied to this specification.

FIG. 5 is an example of a page list to which this specification may be applied.

FIG. 6 is an example of assets to which this specification may be applied.

FIG. 7 is an example of the detection of an event by a convergence type production apparatus to which this specification may be applied.

FIG. 8 is an example of a method of executing results to which this specification may be applied.

FIG. 9 is an example of the management of assets to which this specification may be applied.

FIGS. 10 and 11 are examples of the upload of assets to which this specification may be applied.

FIG. 12 is a block diagram of an AI device according to an embodiment of this specification.

FIG. 13 is an example of a pipeline of a recommendation method to which this specification may be applied.

FIG. 14 is an example of visual coding to which this specification may be applied.

FIG. 15 is an embodiment of a recommendation apparatus to which this specification may be applied.

FIG. 16 is an example of sentence input to which the present specification can be applied.

FIG. 17 is an example of content generation to which this specification can be applied.

FIG. 18 is an example of asset recommendation to which the present specification can be applied.

FIG. 19 is an example of meta information generation to which the present specification can be applied.

The accompanying drawings, which are included as part of the detailed description to assist understanding of the present disclosure, illustrate embodiments of the present disclosure and explain the technical features of the present disclosure together with the detailed description.

### BEST MODE

Hereinafter, embodiments disclosed in this specification are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various components, but the components are not restricted by the terms. The terms are used to only distinguish one element from the other elements.

When it is described that one element is “connected” or “coupled” to another element, it should be understood that one element may be directly connected or coupled to the other element, but a third element may exist between the two elements. In contrast, when it is described that one element is “directly connected to” or “directly coupled to” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

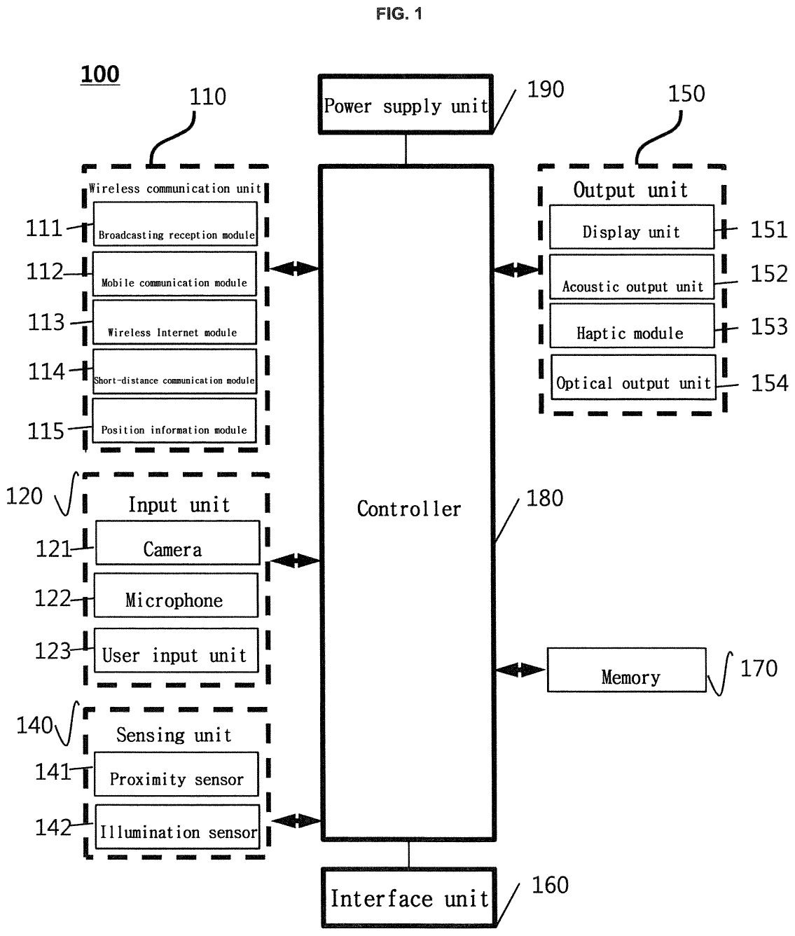

FIG. 1 is a block diagram for describing an electronic device related to this specification.

An electronic device 100 may include a wireless communication unit 110, an input unit 120, a sensing unit 140, an output unit 150, an interface unit 160, memory 170, a controller 180, a power supply unit 190, etc. The components illustrated in FIG. 1 are not essential in implementing the electronic device. The electronic device described in this specification may have more or less components than the components listed above.

More specifically, among the components, the wireless communication unit 110 may include one or more modules that enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcasting reception module 111, a mobile communication module 112, a wireless Internet module 113, a short-distance communication module 114, and a position information module 115.

The input unit 120 may include a camera 121 or an image input unit for receiving an image signal, a microphone 122 or an audio input unit for receiving an audio signal, and a user input unit 123 (e.g., a touch key or a mechanical key) for receiving information from a user. Voice data or image data that is collected by the input unit 120 may be analyzed and processed as a control command of the user.

The sensing unit 140 may include one or more sensors for sensing at least one of information within the electronic device, surrounding environment information around the electronic device, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor, for example, a camera (refer to 121), a microphone (refer to 122), a battery gauge, an environment sensor (e.g., a barometer, a hygrometer, a thermometer, a radioactivity sensor, a thermal sensor, or a gas sensor), a chemical sensor (e.g., an electronic nose, a healthcare sensor, a bio recognition sensor). The electronic device disclosed in this specification may combine and use pieces of information that are sensed by at least two of these sensors.

The output unit 150 is for generating an output related to a visual, auditory, or tactile sense, and may include at least one of a display unit 151, an acoustic output unit 152, a haptic module 153, and an optical output unit 154. The display unit 151 may implement a touch screen by forming a mutual layer structure along with a touch sensor or being integrally formed along with a touch sensor. The touch screen may function as the user input unit 123 that provides an input interface between the electronic device 100 and a user, and may also provide an output interface between the electronic device 100 and a user.

The interface unit 160 may serve as a passage with various types of external devices that are connected to the electronic device 100. The interface unit 160 may include at least one of a wired/wireless headset port, an external charger port, a wired/wireless data port, a memory card port, a port that connects a device equipped with an identification module, an audio input/output (I/O) port, a video I/O port, and an earphone port. The electronic device 100 may perform proper control related to an external device connected thereto, in response to the connection of the external device with the interface unit 160.

Furthermore, the memory 170 may store data that supports various functions of the electronic device 100. The memory 170 may store multiple application programs or applications that are driven in the electronic device 100, data for an operation of the electronic device 100, and instructions. At least some of the application programs may be downloaded from an external server through wireless communication. Furthermore, at least some of the application programs may be present on the electronic device 100 from the time of release for basic functions (e.g., call incoming and outgoing functions and message reception and sending functions) of the electronic device 100. The application program may be stored in the memory 170, may be installed in the electronic device 100, and may be driven to perform an operation (or function) of the electronic device by the controller 180.

The controller 180 commonly controls an overall operation of the electronic device 100 in addition to an operation related to the application program. The controller 180 may provide information or a function suitable for a user or process the information or function by processing a signal, data, or information that is input or output through the aforementioned components or driving an application program stored in the memory 170.

Furthermore, the controller 180 may control at least some of the components that have been described with reference to FIG. 1 in order to drive an application program stored in the memory 170. Moreover, the controller 180 may combine and operate at least two of the components included in the electronic device 100 in order to drive the application program.

The power supply unit 190 may be supplied with external power and internal power under the control of the controller 180, and may supply power to each of the components included in the electronic device 100. The power supply unit 190 includes a battery. The battery may be an embedded type battery or a replaceable type battery.

At least some of the components may cooperatively operate in order to implement an operation, control, or a control method of the electronic device according to various embodiments described hereinafter. Furthermore, the operation, control, or control method of the electronic device may be implemented on the electronic device by the driving of at least one application program stored in the memory 170.

In this specification, the electronic device 100 may include a recommendation apparatus, a terminal, a visual coding apparatus, and a convergence type production apparatus.

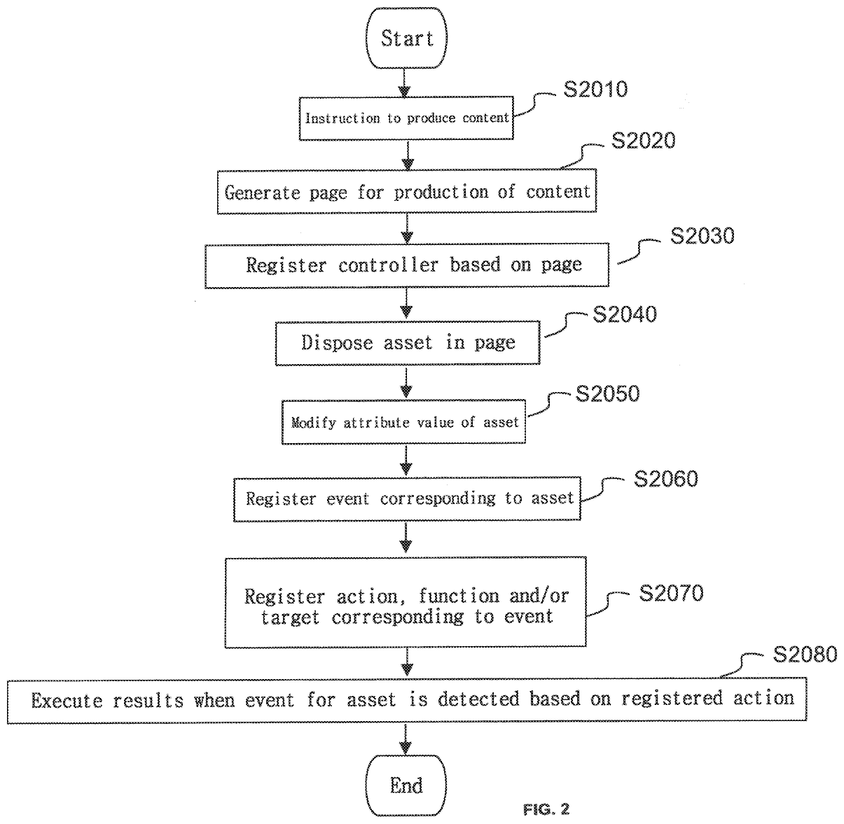

FIG. 2 is an embodiment to which this specification may be applied.

Referring to FIG. 2, a user may communicate with the convergence type production apparatus through the terminal. For example, the terminal may be connected to the convergence type production apparatus through the Web even without a separate application. The user can simultaneously produce two-dimensional (2-D) and three-dimensional (3-D) content through the terminal.

The recommendation apparatus includes an AI device 20 to be described later. The recommendation apparatus is connected to a user terminal and a convergence type production apparatus to analyze a user's propensity using meta information generated from the terminal, the platform, and the convergence type production apparatus, and recommend content and an asset suitable for the user using the analysis result.

For example, the recommendation apparatus may generate JSON sentence data using a large-scale language model framework based on sentences written in an input window by a user through a terminal. In this way, the recommendation apparatus recommends the content generation and asset. By analyzing the uploaded file, JSON sentence data may be generated through a language model framework and stored in asset meta information.

The convergence type production apparatus receives an instruction to produce content from the terminal through the Web (S2010). For example, the content may include a 2-D object and/or a 3-D object.

The convergence type production apparatus generates a page for the production of the content (S2020). For example, the page includes a page which may be represented in a 2-D or 3-D form. The convergence type production apparatus may construct a screen by adding and disposing a predefined asset or template to and in each page. More specifically, an event may be registered with the added asset, so that an interaction with a content user may be added to the added asset. Accordingly, the user may produce immersive and creative content.

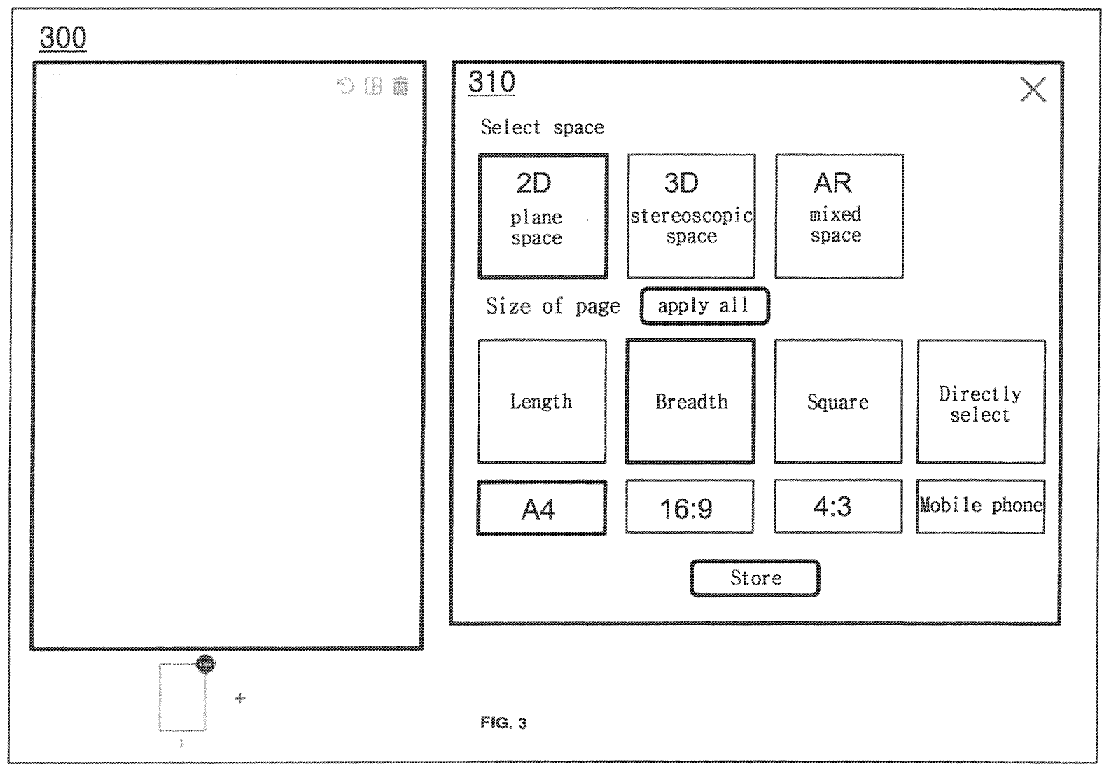

FIG. 3 is an example of the generation of a page to which this specification may be applied.

Referring to FIG. 3, a user may be provided with a page display screen 300 from the convergence type production apparatus through the terminal. For example, one piece of content may include one or more pages. Furthermore, the user may change a form of the page into a 2-D or 3-D form through a layout selection window 310 which may appear on the page display screen 300, and may separately add a virtual space having a special function, such as an AR mode, depending on the demand of a content user. The convergence type production apparatus may register a separate controller 400 based on a form of the page. Furthermore, the user may change the size and ratio of the page through the layout selection window 310.

Referring back to FIG. 2, the convergence type production apparatus registers the controller 400 based on the page (S2030). For example, the convergence type production apparatus may register the controller 400 capable of controlling an asset based on a form of the page and capable of an interaction.

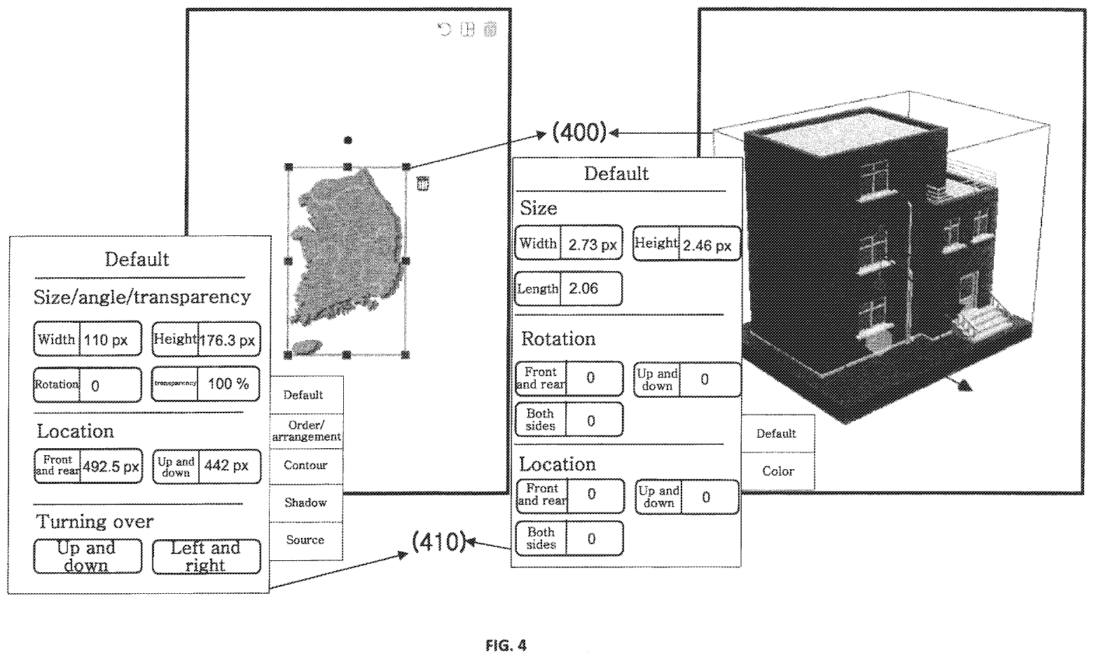

FIG. 4 is an example of the controller 400 which may be applied to this specification.

Referring to FIG. 4, when a user selects an asset through the terminal, an attribute suitable for the asset is displayed in an attribute window 410. The convergence type production apparatus displays the registered controller 400. The user may conveniently edit the attribute by using a mouse or a touch through the controller 400. For example, the user may finely modify attribute values of the asset by inputting accurate numerical values to the attribute window 410. The user may perform an additionally connected function by adding a tab to the attribute window 410. For example, additionally connected functions may include a source, media playback information, etc. of the producer of an asset.

Referring back to FIG. 2, the convergence type production apparatus disposes an asset in the page (S2040). For example, the convergence type production apparatus may dispose a predefined asset/template and/or an additionally uploaded asset based on a form of the page.

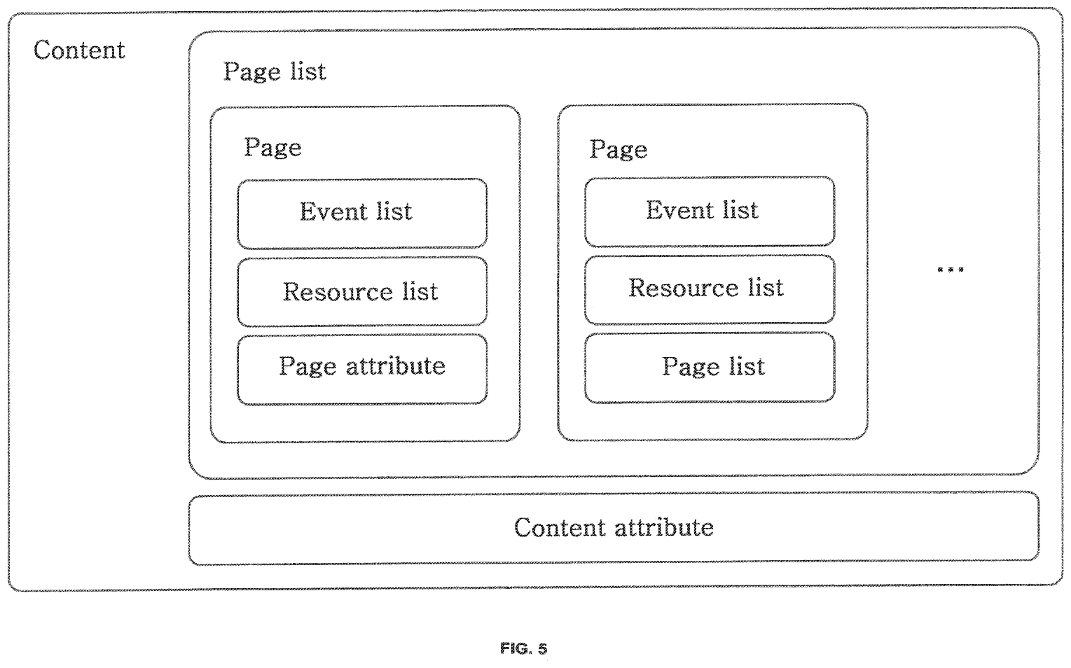

FIG. 5 is an example of a page list to which this specification may be applied.

Referring to FIG. 5, one piece of content is constituted with a bundle of several pages (or screens). A 2-D or 3-D screen may be selected depending on a user's need.

For example, a page may include (1) the attribute of the page, (2) an event list, and (3) a resource list. More specifically, the event list includes information of events assigned to an asset. The resource list includes information of assets added to the page.

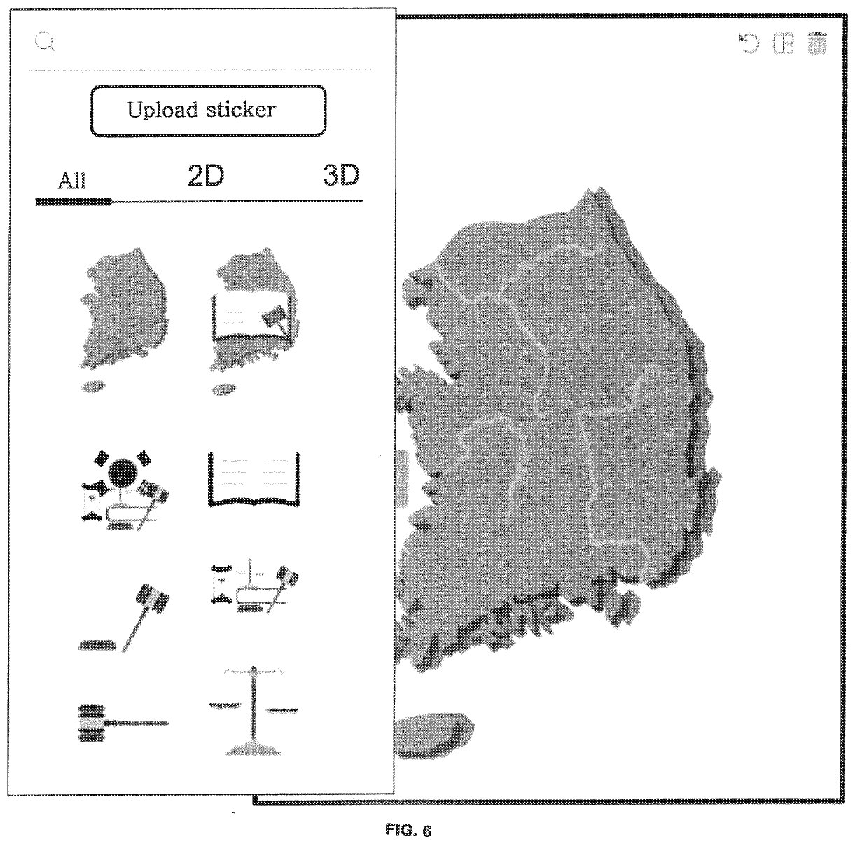

FIG. 6 is an example of assets to which this specification may be applied.

Referring to FIG. 6, the convergence type production apparatus may provide a user with a predefined asset/template based on a form of a page through the terminal. Furthermore, the user may additionally upload and dispose an asset.

Referring back to FIG. 2, the convergence type production apparatus modifies an attribute value of the asset (S2050).

For example, when the user selects an asset disposed on the page display screen 300, the convergence type production apparatus displays the attribute window 410 corresponding to the selected asset. The user may modify an attribute value of the asset by using a mouse, a touch, or the input of numerical values through the registered controller 400 based on a page.

The convergence type production apparatus registers an event corresponding to the asset (S2060). For example, the event may include a set of “actions” and “results”. More specifically, the action may define a condition in which the event occurs. For example, the “action” may include various forms of events or invoking, such as a keyboard event, a mouse/touch event, a gesture event, an area event, a value event, and an invoking event, as a condition in which an “action” function is performed.

Furthermore, the results may include a “function” and a “target”.

More specifically, the “function” may define an attribute change and specific behaviors to be performed on a “target”, that is, the purpose of the function when an event is activated, and may include a control function for the default attributes of an asset, such as a location, a size, rotation, and transparency, and media assets, such as view, hiding, playback, a stop, and a pause. Furthermore, the “function” may include a camera of a user terminal, a GPS, or an accelerometer for using information of an external environment.

The convergence type production apparatus registers an action, function and/or target corresponding to the event (S2070). For example, the convergence type production apparatus may register the action, function and/or target based on the attribute value of the asset.

The convergence type production apparatus executes the results based on the registered action when an event for the asset is detected (S2080).

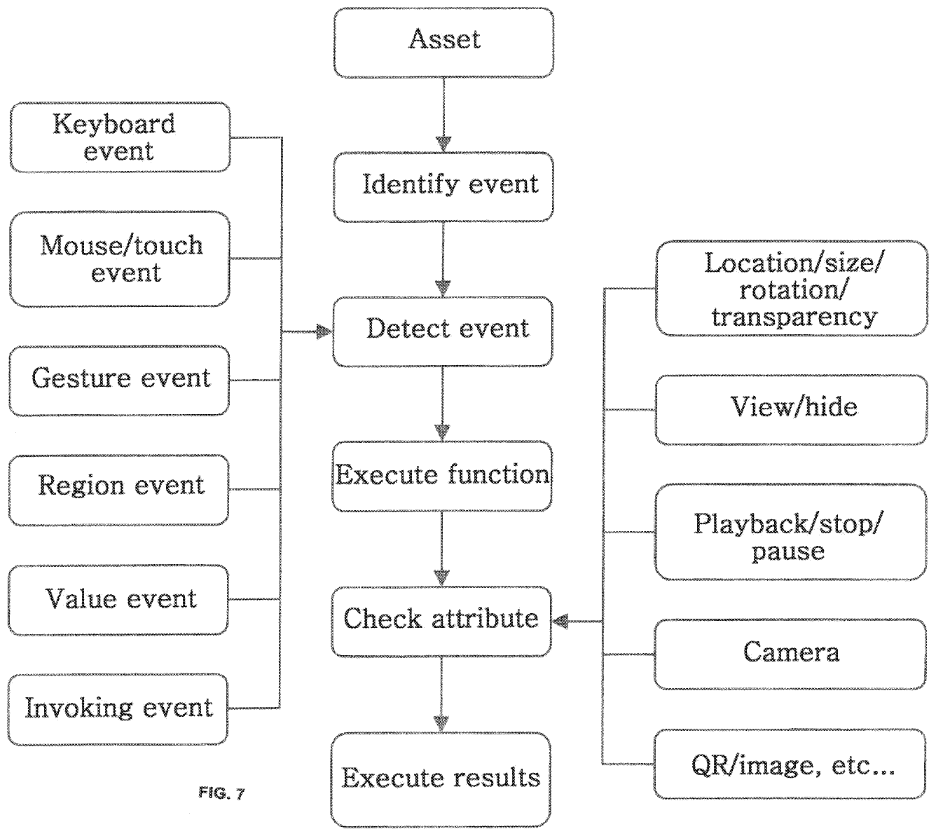

FIG. 7 is an example of the detection of an event by the convergence type production apparatus to which this specification may be applied.

Referring to FIG. 7, the convergence type production apparatus may identify an event corresponding to an asset, and may detect the event by monitoring the event. When the event is detected, the convergence type production apparatus may check an attribute suitable for the asset in order to execute a function corresponding to the event, and may execute results included in the event based on the function and the attribute.

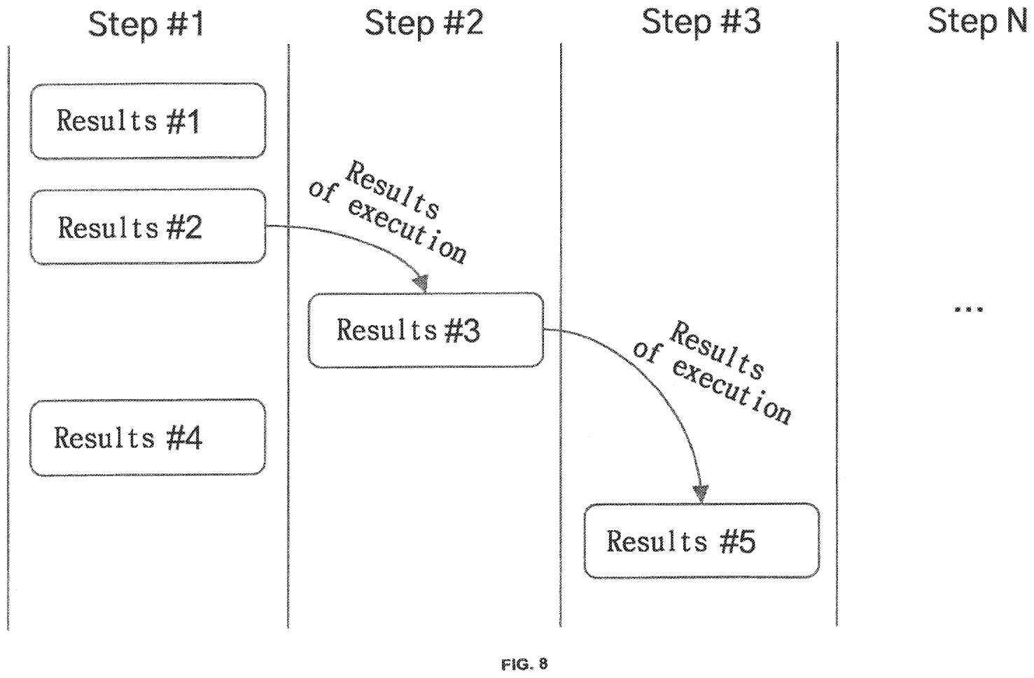

FIG. 8 is an example of a method of executing results to which this specification may be applied.

Referring to FIG. 8, the convergence type production apparatus may simultaneously execute “results”. A down one level “results” may be connected to an up one level “results”, and may be executed in succession with the up one level “results”. Furthermore, the connection of the “results” is not limited. A continuous function in a next step may also be performed by using the results of the execution of the up one level “results”. Unlike an execution method that is simply driven in the form of one time line, such a method of executing results may provide a user with the same environment as that of an actual programming scheme in relation to an asset, and may help to naturally learn a programming environment.

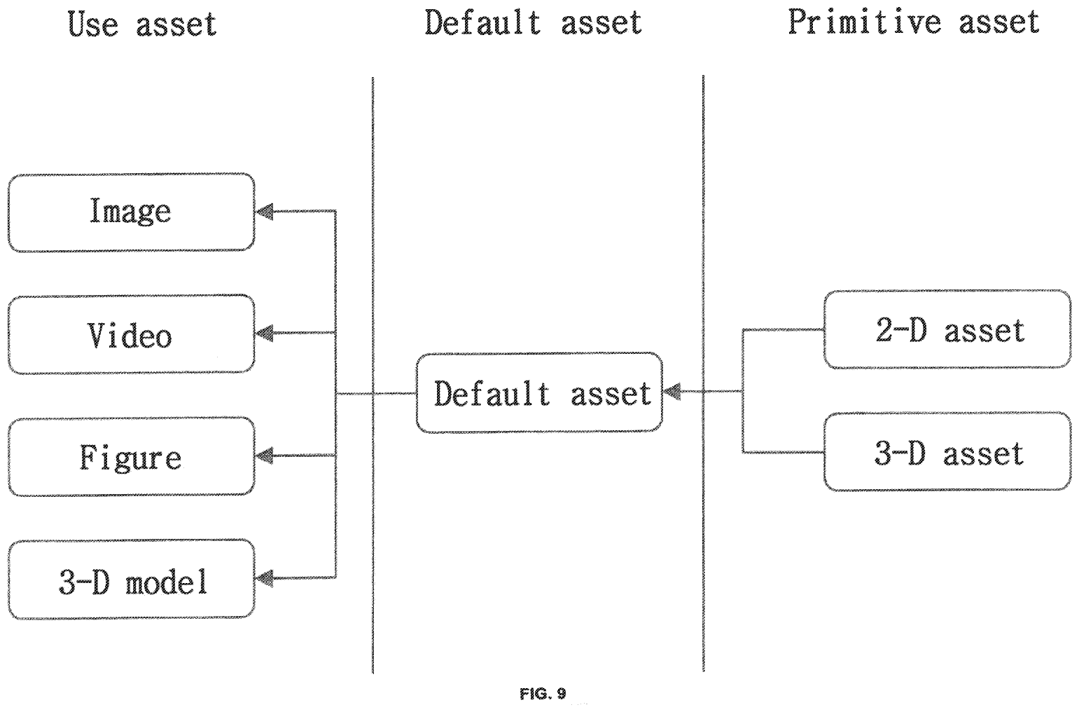

FIG. 9 is an example of the management of assets to which this specification may be applied.

Referring to FIG. 9, it is difficult for the convergence type production apparatus to control an asset having a 2-D form and an asset having a 3-D form by using the same method because the assets have different attributes. For this reason, the convergence type production apparatus first manages the asset having the 2-D form and the asset having the 3-D form in a way that an object called a “default asset” surrounds the asset having the 2-D form and the asset having the 3-D form and is extended to and used as a “use asset” which is used in an authoring tool of the convergence type production apparatus based on the “default asset”. For example, a function of the “use asset” may be constructed to control and use features of a “primitive asset”. More specifically, in FIG. 9, an image, a video, a figure, and a 3-D model have been taken as an example of the “use asset”, but any form that is advantageous in controlling and displaying features of the asset having the 2-D form and the asset having the 3-D form may be indicated as the “use asset”.

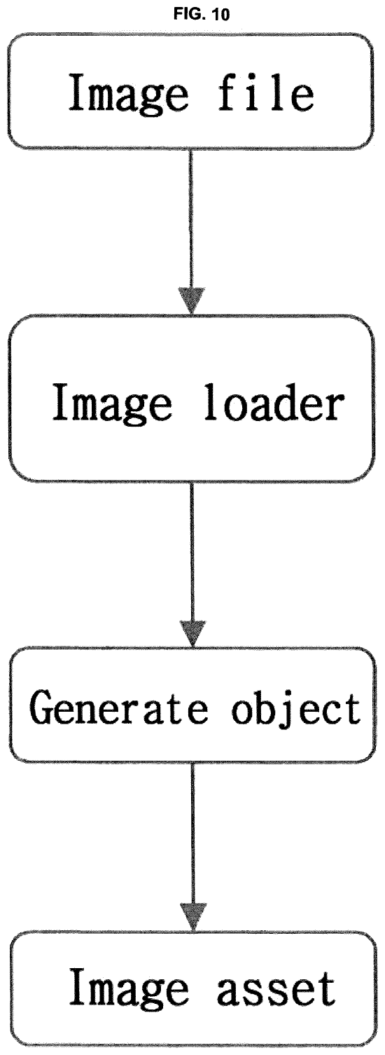

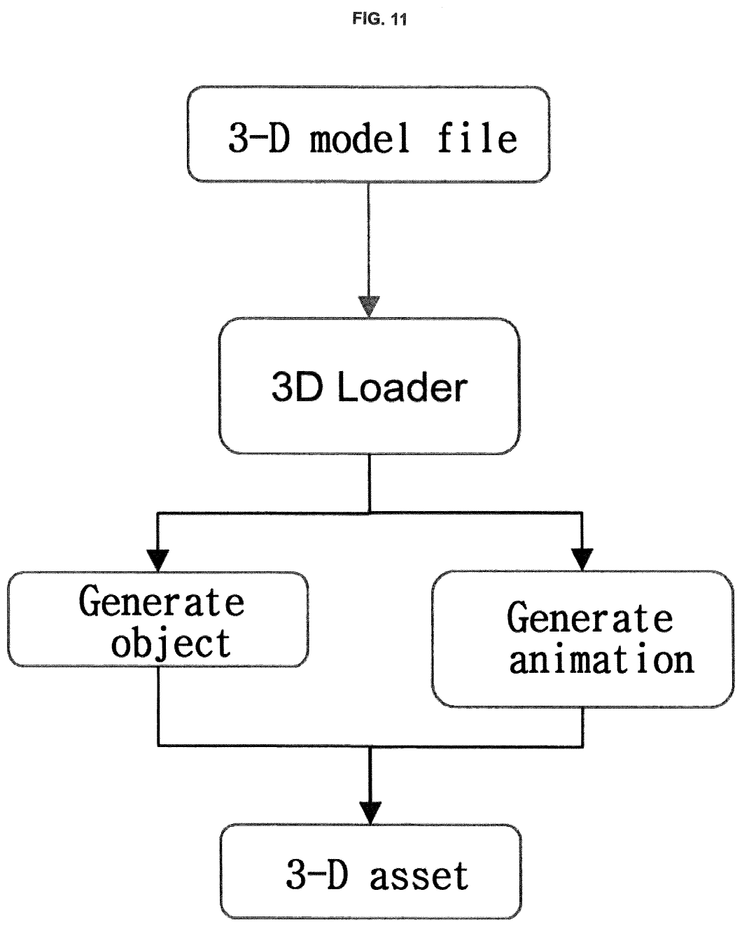

FIGS. 10 and 11 are examples of element upload to which the present specification can be applied.

Referring to FIGS. 10 and 11, the convergence type production apparatus (or platform) loads the uploaded element file through a loader and registers an object of the loaded element file as a “use element” that may correspond to the loader. The convergence type production apparatus may arrange the uploaded elements using the registered “use elements.”

Referring to FIG. 10, if an uploaded asset file is an image file, the convergence type production apparatus may load the image file through an image loader, and may register an object of the loaded image file as an image asset.

Referring to FIG. 11, if an uploaded asset file is a 3-D model file, the convergence type production apparatus may load the 3-D model file through a 3-D loader, may generate an object of the loaded 3-D model file, may generate animation corresponding to the object, may add the animation to the generated object, and may register the object as a 3-D asset.

For example, if an uploaded asset file is a video file, the convergence type production apparatus may generate HTMLVideoElement for the video file, may add the HTMLVideoElement to a screen, may register an object of the HTMLVideoElement as a “use asset”, and may control the object.

One piece of content may include several pages. Each of the pages may include a resource manager “resourceManager” that manages assets and an event manager “eventManager” that manages an operation event.

Assets disposed in a page have separate depths. Accordingly, the convergence type production apparatus may adjust the order of assets that are exposed to a screen by adjusting the depths of the assets depending on a user's need.

For example, when an asset is disposed in a page, the convergence type production apparatus registers the asset with the resource manager of the page, and manages the asset through a change, or the registration or deletion of an attribute, a state, etc. of the asset. The resource manager may manage the disposed asset, and may invoke a connected function according to a change in the resource based on a resource list of the page by generating an event for a change.

When an asset is added, the convergence type production apparatus may add the asset to a management list in order to control the asset through a controller registered with a page in which the asset is disposed so that the asset can be recognized and managed as an asset which may be controlled by the controller. An attribute of the asset registered with the controller may be modified or controlled through a mouse, a gesture, a touch, an external controller, etc. of a user.

Furthermore, a Redo/Undo function may be required in a process of a user controlling an asset. To this end, the convergence type production apparatus may construct a history manager of a page in which the asset is disposed so that the history manager may record a change in the state of the asset by storing a change in the controller, may invoke the attribute of the asset from a list including the change, which is kept in the history manager in response to a request, and may restore or update again the state of the asset by updating a current attribute of the asset. The history manager may have a memory capacity problem because a change is stored for each asset. Accordingly, in order to prevent the memory capacity problem, the convergence type production apparatus may restrict the number of lists of changes that are stored depending on circumstances.

Furthermore, the convergence type production apparatus may designate a user with which content will be shared when the content is produced, and may perform the task of producing the content simultaneously with the user. For example, when content is initially produced, the convergence type production apparatus may generate a unique channel corresponding to the content. The convergence type production apparatus may designate a sharing user who may use the unique channel, and may add the sharing user to the same channel when the user accesses the content.

The user in the same channel may synchronize authoring data in real time while exchanging a change in the authoring data in real time. Communication for the synchronization may be performed in real time through websocket or webrtc.

However, when a new user accesses content that has not been stored, a difference between a version of the content that has not been stored and a previous version of the content that has been stored may occur because the user is synchronized with a state of the content having the previous version. In order to prevent such a problem, when a new user is added to a sharing channel and first accesses content, initial synchronization may be performed by performing an overall update on a task change through a specific user among users who are performing the existing task. After the initial synchronization is performed as described above, the convergence type production apparatus may solve a synchronization issue for content that has not been stored through a method of sharing data having a change in real time.

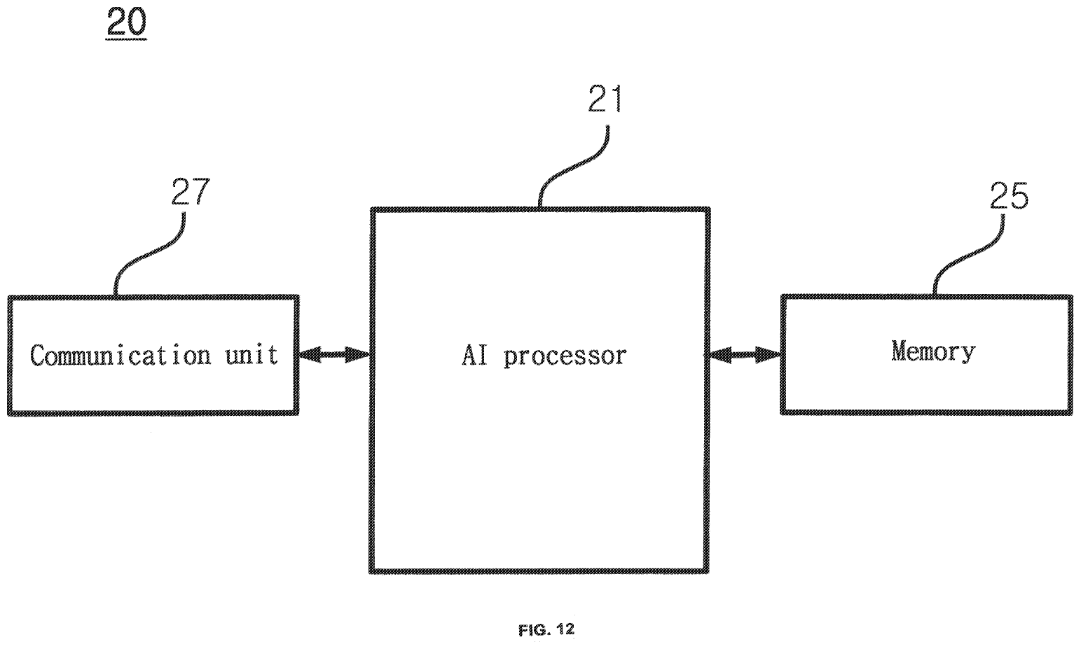

FIG. 12 is a block diagram of an artificial intelligence (AI) device according to an embodiment of the present specification.

The AI device 20 may include an electronic device including an AI module capable of performing AI processing, a server including the AI module, or the like. In addition, the AI device 20 may be included in at least a part of the electronic device 100 illustrated in FIG. 1 and may be provided to perform at least a part of the AI processing together.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, and a tablet PC.

The AI processor 21 may train a neural network using a program stored in the memory 25. For example, the AI processor 21 may generate a Tensorflow-utilized recurrent neural networks model on the memory 25, and use data that may be collected from the user terminal, the convergence production apparatus, and the like to train these AI models.

For example, the trained artificial intelligence model may include a language model, and generate sub-models having the following tasks:
1. Content Recommendation Model: Recommend/generate customized contents for users by utilizing data obtained by analyzing content usage information and content production information and a user characteristic model
2. Element Recommendation Model: Recommend customized asset to a content producer using a user characteristic model and asset meta information
3. User Characteristics Analysis Model: Analyze user's characteristics through analysis of user's learning interest, participation, immersion, and the like.

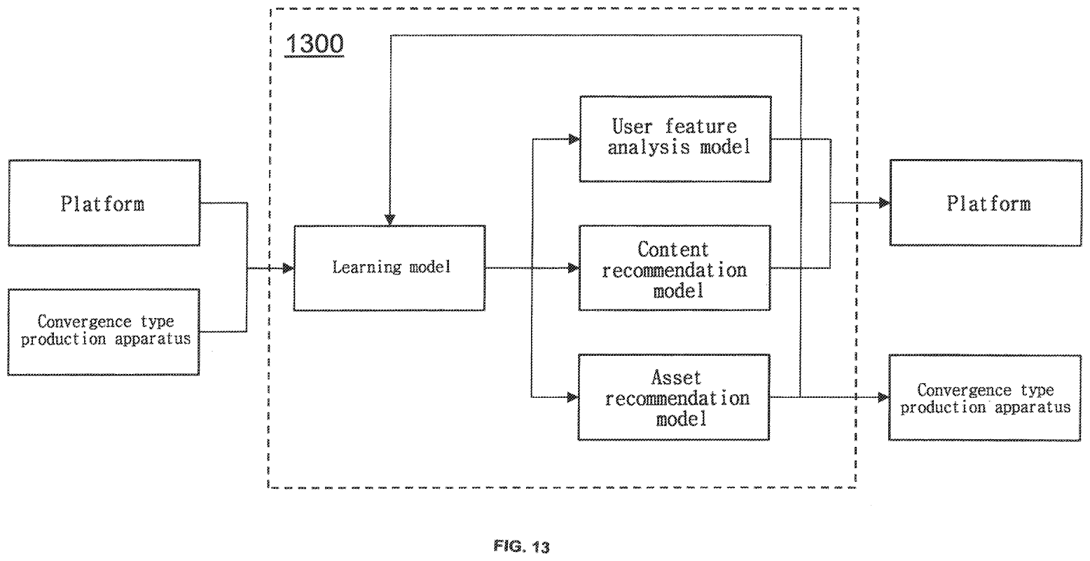

FIG. 13 is an example of a recommendation method pipeline to which the present specification may be applied.

Referring to FIG. 13, an artificial intelligence model 1300 may be trained using data collected from a platform and a converged production apparatus.

For example, the platform may be provided to a terminal through the WEB, and may be connected to the convergence type production device to provide a content production environment to a user. In addition, content produced by other users may be displayed, and a search function for the content may be provided. In addition, the platform may provide a user with a template that may be used in a content production environment, and may also provide a search function for the template.

The trained artificial intelligence model may generate 1) a user characteristic analysis model, 2) a content recommendation model, and 3) an element recommendation model. The user characteristics output by the user characteristic analysis model may be used for training of the artificial intelligence model 1300.

In addition, the content recommendation model may receive sentences from the user, transform the sentences into JSON type sentence data, and provide automatically generated content to a user through the convergence type production apparatus.

In addition, the element recommendation model may recommend an asset to a user through the convergence type production device using the JSON type sentence data.

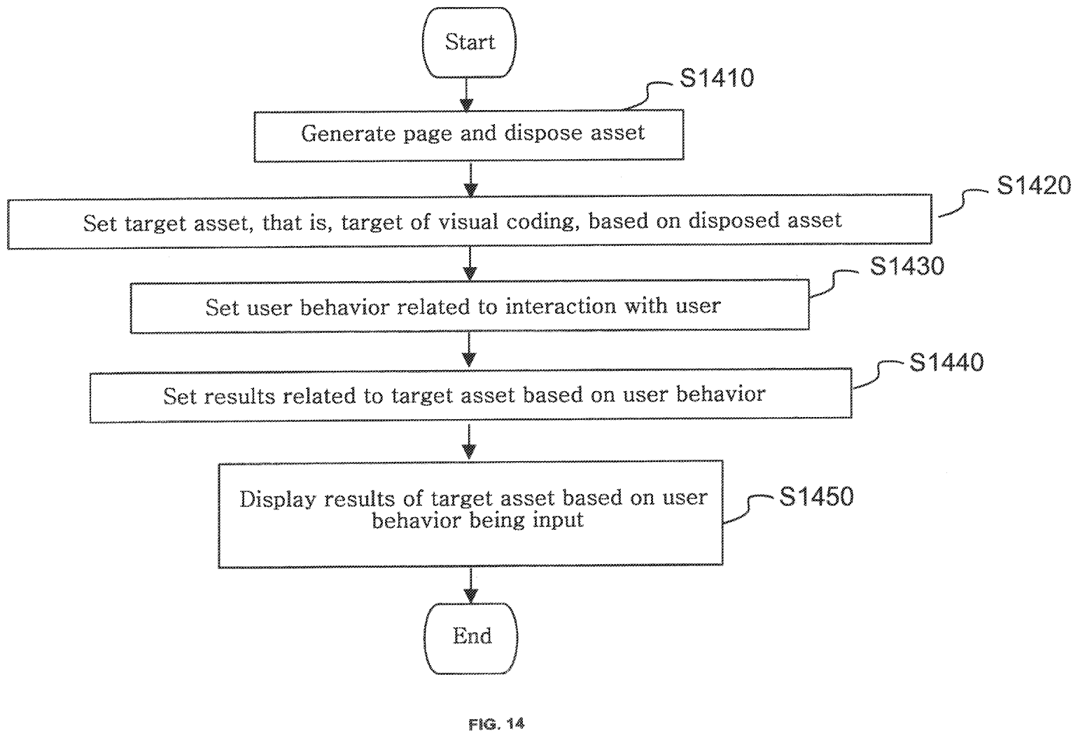

FIG. 14 is an example of visual coding to which this specification may be applied.

Referring to FIG. 14, a user may communicate with the visual coding apparatus through the terminal. For example, the convergence type production apparatus may include the visual coding apparatus.

Furthermore, the terminal may be connected to the visual coding apparatus through the Web even without a separate application. A user may produce content through visual coding by using the terminal.

The terminal generates a page for visual coding, and disposes an asset in the page (S1410). For example, the terminal may provide the user with a list of assets and/or a template including assets. The user may select, from the template, an asset to be disposed in the page.

The terminal sets a target asset, that is, the target of visual coding, based on the disposed asset (S1420). For example, a user may select the target asset, among assets disposed in the page, by clicking on the target asset.

The terminal sets a user behavior related to an interaction with the user (S1430). For example, the user behavior may be a condition in which an event of the target asset occurs.

The terminal sets results related to the target asset, based on the user behavior (S1440). For example, the results may mean an operation which is performed in relation to the target asset, when the terminal receives, from the user, an input corresponding to the user behavior. The results may include a “function” for controlling the size, location, and state value of the target asset, an “operation” for operating variables related to the target asset, and a “function page” indicative of a movement of a page.

The terminal displays the results of the target asset based on the user behavior being input (S1450). For example, when one click on the target asset is received from a user, the terminal may move the target asset for 1 second or display a screen that has been moved to another page, as the results.

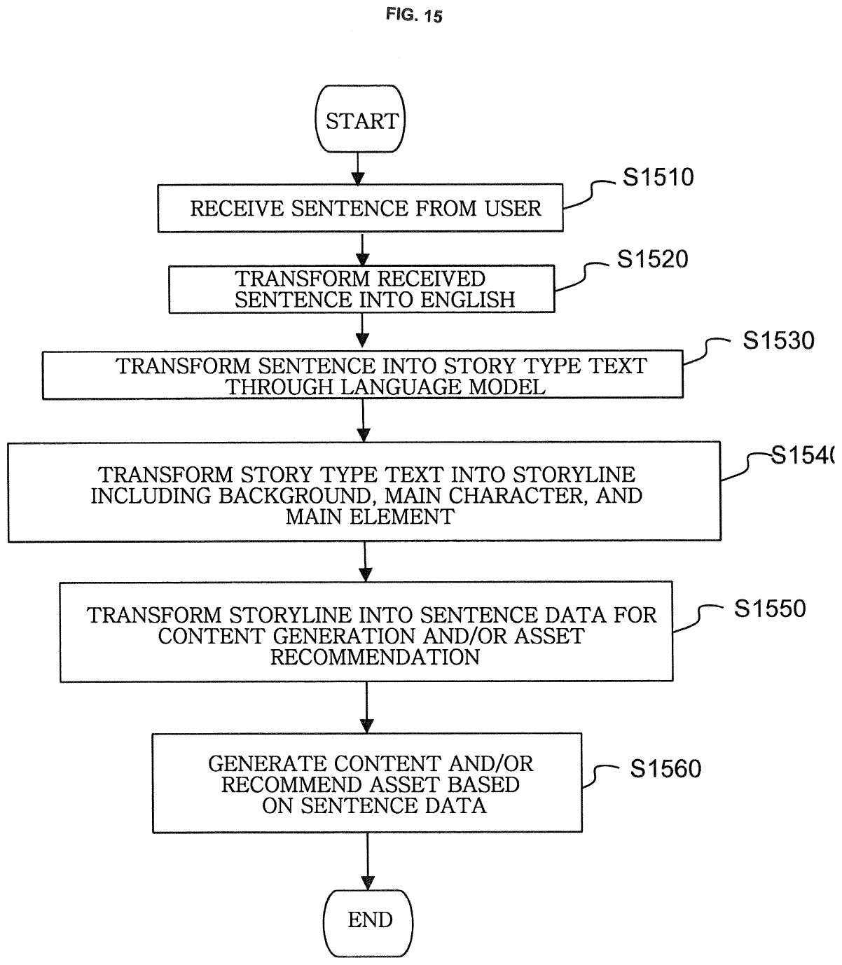

FIG. 15 is an embodiment of the recommendation apparatus to which the present specification can be applied.

Referring to FIG. 15, the recommendation apparatus is connected to the user terminal and the convergence type production apparatus, trained through the collected data, and provides predicted output values to the platform and the convergence type production apparatus through the trained artificial intelligence model. For example, the convergence type production apparatus may include an authoring tool for content production.

The recommendation apparatus receives sentences from the user through the convergence type production apparatus and/or platform (S1510). For example, a user may input a sentence about a specific topic or story to the convergence type production apparatus to produce content. In more detail, the user can input the sentence “blue sky and grass with a smiley sun” into the convergence type production apparatus. In this case, the input language may be mainly Korean, and the recommendation apparatus may store the input sentence for the follow-up process.

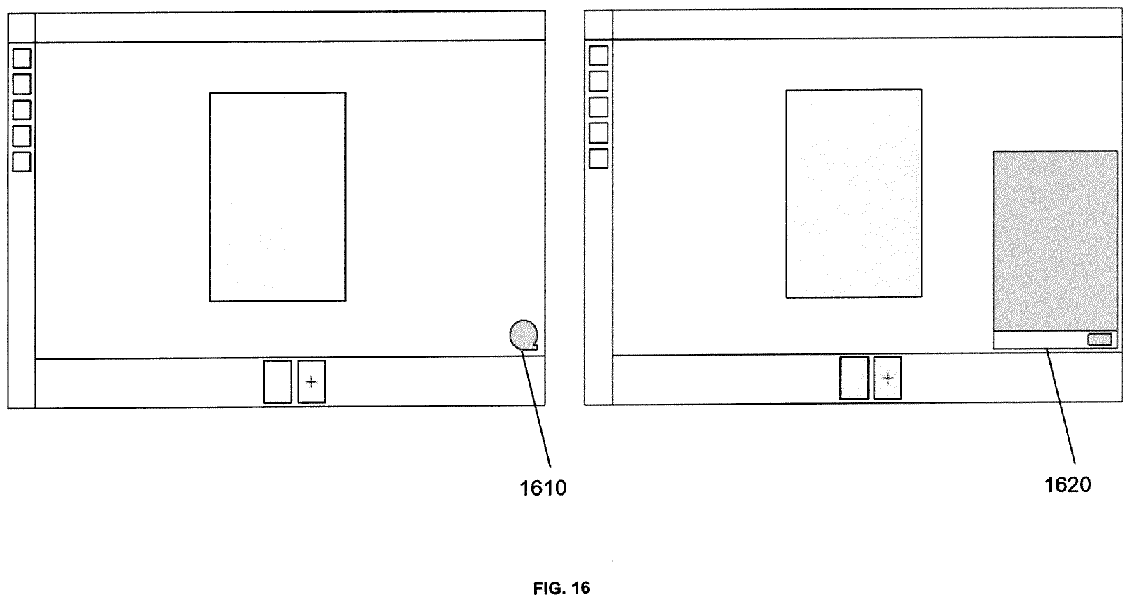

FIG. 16 is an example of sentence input to which the present specification can be applied.

Referring to FIG. 16, a user may select a chatting icon 1610 for text input on a screen for producing content. The convergence type production apparatus may activate a chatting function when receiving a chatting icon 1610. Through the chat window 1620 displayed through the terminal, the user may input a sentence for generating content.

Referring back to FIG. 15, the recommendation apparatus transforms the received sentence into English (S1520). When the received sentence is languages other than English, the received sentence may be transformed into English for accuracy of the language model included in the recommendation apparatus.

For example, the sentence “Blue sky and grass with a smiley sun” may be converted into an English sentence “Blue sky and grass with a smile.”

The recommendation apparatus transforms a sentence into a story type text through a language model (S1530). In more detail, the template of the language model may be configured to issue the command Write a synopsis about the “blue sky and grass with a smile” for the sentence “Blue sky and grass with a smile”.

For example, “Blue sky and grass with a smile” may be transformed into the story type text as follows.

In the enchanting world of “Blue Sky and Grass with a Smile,” we are transported to a serene and picturesque landscape where the beauty of the blue sky and lush green grass becomes a catalyst for transformation. The story revolves around Emily, a young girl grappling with the hardships of life and burdened by sorrow. However, one fateful day, she stumbles upon a hidden meadow, bathed in the golden sunlight, where the sky is a vivid shade of blue and the grass dances with an infectious joy.

As Emily immerses herself in this magical haven, she starts to notice how the vibrant hues of the sky and grass affect her mood. The brilliant blue sky acts as a gentle reminder to look beyond her troubles and find hope, while the cheerful green grass inspires her to embrace the present moment and seek happiness. Slowly but surely, a smile starts to grace Emily's face as she discovers the power of perspective and the healing balm of nature.

With each visit to the meadow, Emily's connection to the blue sky and grass deepens. She begins to cultivate a profound sense of gratitude for the beauty surrounding her, finding solace and strength in the simplicity of life's wonders. The radiant smile that forms on her lips becomes a beacon of optimism, influencing those around her and spreading contagious joy.

Through this poignant journey, “Blue Sky and Grass with a Smile” highlights the transformative power of nature and the profound impact it can have on our emotional well-being. It reminds us to find solace in the smallest of moments, to appreciate the beauty that surrounds us, and to nurture a smile that can illuminate even the darkest of days.

This is to compensate for the fact that the sentence input by a first user has insufficient information for content generation and/or asset recommendation.

The recommendation apparatus transforms the story type text into a storyline including a background, a main character, and main elements through a language model (S1540). The recommendation apparatus analyzes the story type text by utilizing the language model again, and may be summarized as a storyline by condensing the story type text into one scene including the background, main characters, and main elements. This is to extract key elements of content, and the recommendation apparatus may generate a storyline by extracting the key elements such as the background, main characters, and main elements among many data included in the story type text.

To this end, the template of the language model may be set to Summarize the storyline in three lines, including the background, main characters, and main elements.

For example, the story type text exemplified in S1530 described above may be transformed into a storyline as follows.

In “Blue Sky and Grass with a Smile,” Emily, a young girl burdened by sorrow, discovers a hidden meadow where the vibrant blue sky and dancing green grass become catalysts for transformation. Immersed in this magical haven, she learns to find hope, embrace the present, and cultivate gratitude. Through the healing power of nature, Emily's radiant smile becomes a symbol of optimism, inspiring those around her and reminding us to appreciate life's simple wonders.

The recommendation apparatus transforms the storyline into the sentence data for the content generation and/or asset recommendation (S1550). If necessary, the recommendation apparatus may translate the storyline back into Korean. For example, the storyline exemplified in S1540 described above may be translated as follows.

“In “With the Smile of the Sky and Grass,” Emily, a grieving girl, discovers a hidden meadow where vibrant blue sky and dancing green grass are a starting point for change. As she immerses herself in this magical place, she learns to find her hope, accept the present, and cultivate gratitude. Through her natural healing powers, Emily's radiant smile has become a symbol of optimism, inspires those around her and reminds us to realize the simple beauty of life.” In addition, the recommendation apparatus may transform the storyline into JSON type sentence data based on source words, English words, classification, zero classification, importance, and parts of speech using the language model.

Table 1 below illustrates sentence data.

TABLE 1

{
”original”:” [symbol] [symbol]
″sentence″:

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

″words″: [
{
″text″: [symbol]
″english″: ″sky and″,
″classification″: [symbol]
″english_classification″: ″noun″,
″importance″: 3,
″part_of_speech″: ″NNG″
},
{
″text″: [symbol]
″english″: ″grass with″,
″classification″: [symbol]
″english_classification″: ″noun″,
″importance″: 3,
″part_of_speech″: ″NNG″
},
}
″text″: [symbol]
″english″: ″smile and″,
″classification″: [symbol]
″english_classification″: ″noun″,
″importance″: 3,
″part_of_speech″: ″NNG″
},
{
″text″: [symbol]
″english″: ″with a smile″,
″classification″: [symbol]
″english_classification″: ″adverb″,
″importance″: 2,
″part_of_speech″: ″MAG″
},
{
″text″: [symbol]
″english″: ″by sorrow″,
″classification″: [symbol]
″english_classification″: ″noun″,
″importance″: 3,
″part_of_speech″: ″NNG″
},
{
″text″: [symbol]
″english″: ″burdened″,
″classification″: [symbol]
″english_classification″: ″adjective″,
″importance″: 3,
″part_of_speech″: ″VA″
},
{
″text″: [symbol]
″english″: ″girl″,
″classification″: [symbol]
″english_classification″: ″noun″,
″importance″: 3,
″part_of_speech″: ″NNG″
},
{
″text″: [symbol]
″english″: ″Emily,″,
″classification″: [symbol]
″english_classification″: ″noun″,
″importance″: 3,
″part_of_speech″: ″NNP″
},
{
″text″: [symbol]
″english″: ″vibrant″,
″classification″: [symbol]
″english_classification″: ″adjective″,
″importance″: 3,
″part_of_speech″: ″VA″
},
{
″text″: [symbol]
″english″: ″blue″,
″classification″: [symbol]
″english_classification″: ″adjective″,
″importance″: 3,
″part_of_speech″: ″VA″
},
{
″text″: [symbol]
″english″: ″sky″,
″classification″: [symbol]
″english_classification″: ″noun″,
″importance″: 3,
″part_of_speech″: ″NNG″
},
{
″text″: [symbol]
″english″: ″dancing″,
″classification″: [symbol]
″english_classification″: ″verb″,
″importance″: 3,
″part_of_speech″: ″VV+ETM″
},
{
″text″: [symbol]
″english″: ″green″,
″classification″: [symbol]
″english_classification″: ″adjective″,
″importance″: 3,
″part_of_speech″: ″VA″
},
{
″text″: [symbol]
″english″: ″grass″,
″classification″: [symbol]
″english_classification″: ″noun″,
″importance″: 3,
″part_of_speech″: ″NNG″
},
{
″text″: [symbol]
″english″: ″transformation″,
″classification″: [symbol]
″english_classification″: ″noun″,
″importance″: 3,
″part_of_speech″: ″NNG″
},
{
″text″: [symbol]
″english″: ″catalysts for″,
″classification″: [symbol]
″english_classification″: ″noun″,
″importance″: 3,
″part_of_speech″: ″NNG″
},
{
″text″: [symbol]
″english″: ″become″,
″classification″: [symbol]
″english_classification″: ″verb″,
″importance″: 3,
″part_of_speech″: ″VV+ETM″
},
{
″text″: [symbol]
″english″: ″hidden″,
″classification″: [symbol]
″english_classification″: ″adjective″,
″importance″: 3,
″part_of_speech″: ″VA″
},
{
″text″: [symbol]
″english″: ″meadow″,
″classification″: [symbol]
″english_classification″: ″noun″,
″importance″: 3,
″part_of_speech″: ″NNG″
},
{
″text″: [symbol]
″english″: ″discovers″,
″classification″: [symbol]
″english_classification″: ″verb″,
″importance″: 3,
″part_of_speech″: ″VV+EC″
},
{
″text″: [symbol]
″english″: [symbol]
″classification″: [symbol]
″english_classification″: ″pronoun″,
″importance″: 1,
″part_of_speech″: ″MM″
},
{
″text″: [symbol]
″english″: ″magical″,
″classification″: [symbol]
″english_classification″: ″noun″,
″importance″: 3,
″part_of_speech″: ″NNG″
},
{
″text″: [symbol]
″english″: ″like″,
″classification″: [symbol]
″english_classification″: ″adjective″,
″importance″: 3,
″part_of_speech″: ″VA″
},
{
″text″: [symbol]
″english″: ″place″,
″classification″: [symbol]
″english_classification″: ″noun″,
″importance″: 2,
″part_of_speech″: ″NNG″
},
{
″text″: [symbol]
″english″: ″immersing″,
″classification″: [symbol]
″english_classification″: ″verb″,
″importance″: 2,
″part_of_speech″: ″VV+EC″
},
{
″text″: [symbol]
″english″: ″she″,
″classification″: [symbol]
″english_classification″: ″pronoun″,
″importance″: 2,
″part_of_speech″: ″NP″
},
{
″text″: [symbol]
″english″: ″hope″,
″classification″: [symbol]
″english_classification″: ″noun″,
″importance″: 3,
″part_of_speech″: ″NNG″
},
{
″text″: [symbol]
″english″: ″finds″,
″classification″: [symbol]
″english_classification″: ″verb″,
″importance″: 2,
″part_of_speech″: ″VV+EC″
},
{
″text″: [symbol]
″english″: ″the present″,
″classification″: [symbol]
″english_classification″: ″noun″,
″importance″: 2,
″part_of_speech″: ″NNG″
},
{
″text″: [symbol]
″english″: ″accepting″,
″classification″: [symbol]
″english_classification″: ″verb″,
″importance″: 2,
″part_of_speech″: ″VV+EC″
},
{
″text″: [symbol]
″english″: ″gratitude″,
″classification″: [symbol]
″english_classification″: ″noun″,
″importance″: 2,
″part_of_speech″: ″NNG″
},
{
″text″: [symbol]
″english″: ″cultivating″,
″classification″: [symbol]
″english_classification″: ″verb″,
″importance″: 2,
″part_of_speech″: ″VV+ETM″
},
{
″text″: [symbol]
″english″: ″the way″,
″classification″: [symbol]
″english_classification″: ″noun″,
″importance″: 2,
″part_of_speech″: ″NNG″
},
{
″text″: [symbol]
″english″: ″learn″,
″classification″: [symbol]
″english_classification″: ″verb″,
″importance″: 2,
″part_of_speech″: ″VV+EC″
},
{
″text″: [symbol]
″english″: ″become″,
″classification″: [symbol]
″english_classification″: ″verb″,
″importance″: 2,
″part_of_speech″: ″VV+EC″
},
{
″text″: [symbol]
″english″: ″nature's″,
″classification″: [symbol]
″english_classification″: ″noun″,
″importance″: 3,
″part_of_speech″: ″NNG″
},
{
″text″: [symbol]
″english″: ″healing power″,
″classification″: [symbol]
″english_classification″: ″noun″,
″importance″: 3,
″part_of_speech″: ″NNG″
},
{
″text″: [symbol]
″english″: ″through″,
″classification″: [symbol]
″english_classification″: ″particle″,
″importance″: 1,
″part_of_speech″: ″JKM″
},
{
″text″: [symbol]
″english″: ″Emily's″,
″classification″: [symbol]
″english_classification″: ″noun″,
″importance″: 2,
″part_of_speech″: ″NNG″
},
{
″text″: [symbol]
″english″: ″shining″,
″classification″: [symbol]
″english_classification″: ″adjective″,
″importance″: 3,
″part_of_speech″: ″VA″
},
{
″text″: [symbol]
″english″: ″smile″,
″classification″: [symbol]
″english_classification″: ″noun″,
″importance″: 2,
″part_of_speech″: ″NNG″
},
{
″text″: [symbol]
″english″: ″optimism's″,
″classification″: [symbol]
″english_classification″: ″noun″,
″importance″: 3,
″part_of_speech″: ″NNG″
},
{
″text″: [symbol]
″english″: ″symbol″,
″classification″: [symbol]
″english_classification″: ″noun″,
″importance″: 2,
″part_of_speech″: ″NNG″
},
{
″text″: [symbol]
″english″: ″becomes″,
″classification″: [symbol]
″english_classification″: ″verb″,
″importance″: 2,
″part_of_speech″: ″VV+EC″
},
{
″text″: [symbol]
″english″: ″that″,
″classification″: [symbol]
″english_classification″: ″pronoun″,
″importance″: 1,
″part_of_speech″: ″NP″
},
{
″text″: [symbol]
″english″: ″surrounding″,
″classification″: [symbol]
″english_classification″: ″noun″,
″importance″: 2,
″part_of_speech″: ″NNG″
},
{
″text″: [symbol]
″english″: ″to people″,
″classification″: [symbol]
″english_classification″: ″noun″,
″importance″: 2,
″part_of_speech″: ″NNG+JKO″
},
{
″text″: [symbol]
″english″: ″inspiration″,
″classification″: [symbol]
″english_classification″: ″noun″,
″importance″: 2,
″part_of_speech″: ″NNG″
},
{
″text″: [symbol]
″english″: ″and″,
″classification″: [symbol]
″english_classification″: ″conjunction″,
″importance″: 1,
″part_of_speech″: ″JC″
},
{
″text″: [symbol]
″english″: ″to us″,
″classification″: [symbol]
″english_classification″: ″pronoun″,
″importance″: 2,
″part_of_speech″: ″NP+JKO″
},
{
″text″: [symbol]
″english″: ″life's″,
″classification″: [symbol]
″english_classification″: ″noun″,
″importance″: 2,
″part_of_speech″: ″NNG″
},
{
″text″: [symbol]
″english″: ″simple″,
″classification″: [symbol]
″english_classification″: ″adjective″,
″importance″: 3,
″part_of_speech″: ″VA″
},
{
″text″: [symbol]
″english″: ″beauty″,
″classification″: [symbol]
″english_classification″: ″noun″,
″importance″: 2,
″part_of_speech″: ″NNG″
},
{
″text″: [symbol]
″english″: ″realize″,
″classification″: [symbol]
″english_classification″: ″verb″,
″importance″: 2,
″part_of_speech″: ″VV+EC″
},
{
″text″: [symbol]
″english″: ″remind″,
″classification″: [symbol]
″english_classification″: ″verb″,
″importance″: 2,
″part_of_speech″: ″VV+EC″
},
{
″text″: [symbol]
″english″: ″us″,
″classification″: [symbol]
″english_classification″: ″pronoun″,
″importance″: 1,
″part_of_speech″: ″NP″
}
]
}

Referring to Table 1, the recommendation apparatus may convert the storyline type text for the first input sentence into the JSON type data. The JSON type data may be used as data for automatic content generation and/or asset recommendation. The JSON type data may include sentence data information such as background, main characters, and main elements.

The recommendation apparatus recommends content generation and/or assets based on sentence data (S1560).

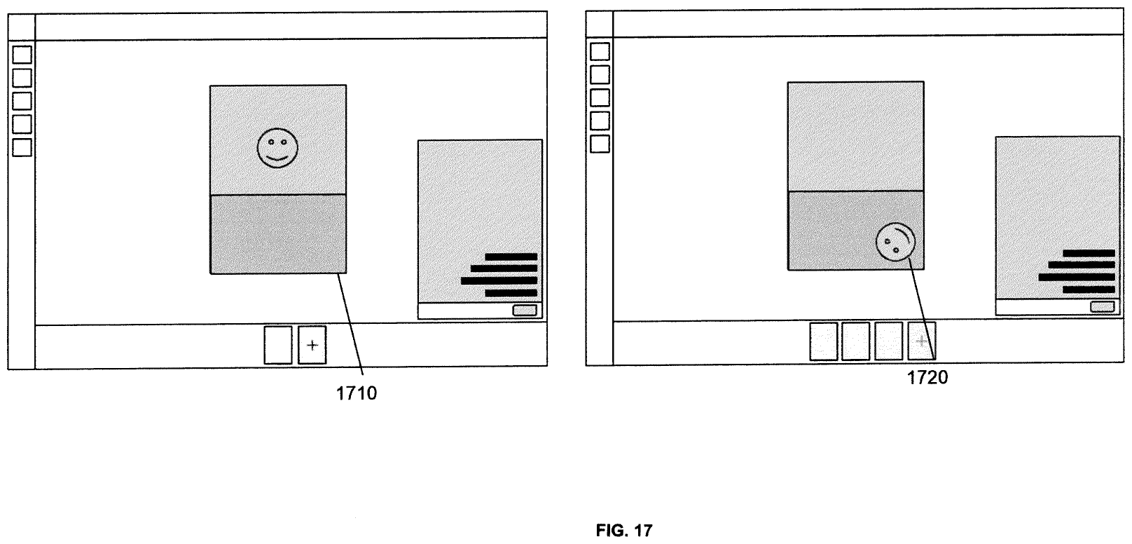

FIG. 17 is an example of content generation to which this specification can be applied.

Referring to FIG. 17, the recommendation apparatus may generate content based on the sentence data, transfer the generated content to the convergence type production apparatus, and display the generated data to the user.

For example, content 1710 in the form of a smiley sun included in the blue sky and grass laid at the bottom may be generated for the sentence “Blue sky and grass with a smiley sun.”

In addition, the recommendation apparatus may add an animation 1720 to the smile element included in the generated content 1710 based on sentence data.

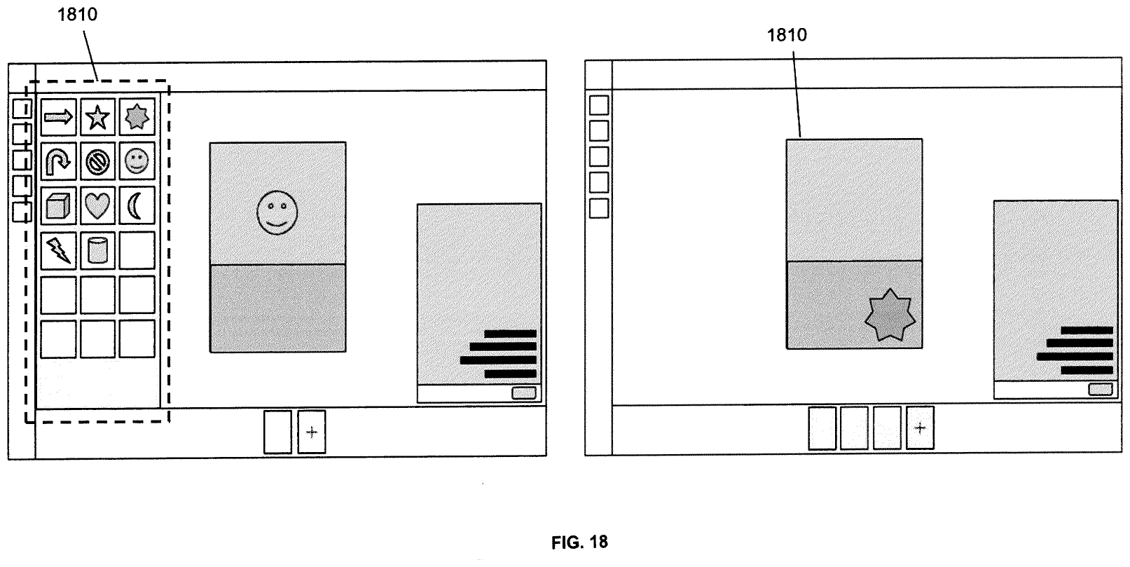

FIG. 18 is an example of asset recommendation to which the present specification can be applied.

Referring to FIG. 18, the recommendation apparatus may recommend an asset based on the sentence data, transfer the recommended asset to the convergence type production apparatus, and display the recommended data to the user (1810).

A user may select an asset from the recommended asset list 1810 and utilize the selected asset as an element displayed in the content 1820.

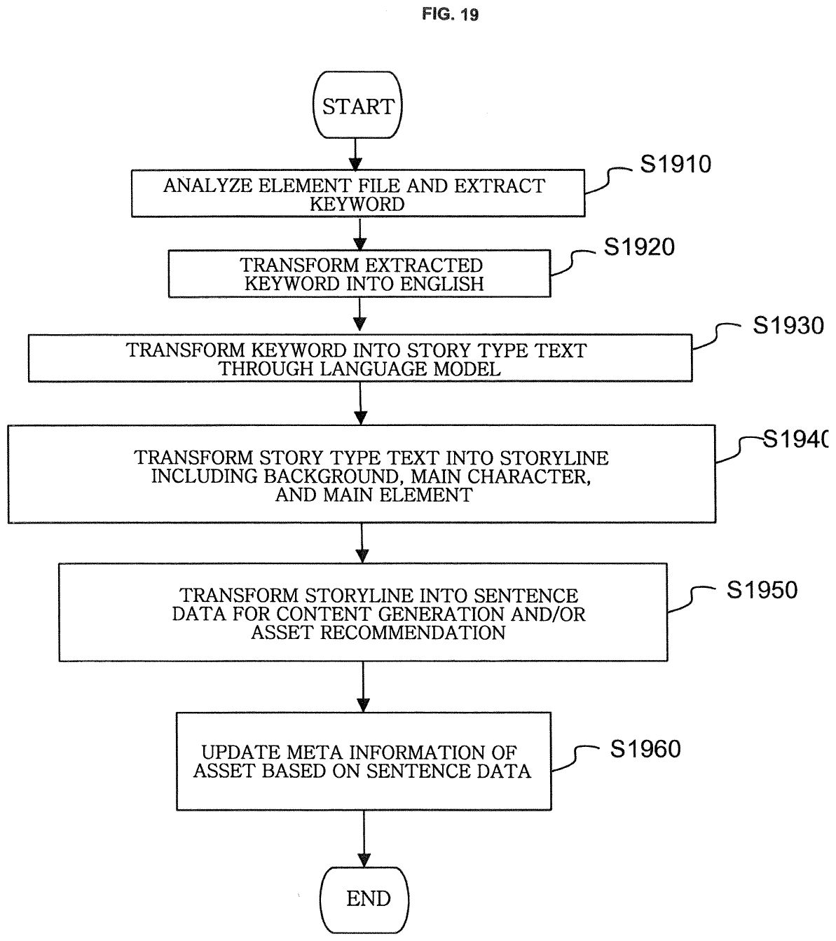

FIG. 19 is an example of meta information generation to which the present specification can be applied.

Referring to FIG. 19, an element file uploaded by a user may be transferred to the recommendation apparatus through the platform. For example, through the platform, users may upload element files including information about elements to be sold. The recommendation apparatus may generate the meta information in the same/similar method to the method of FIG. 15 described above based on the uploaded element file.

The recommendation apparatus analyzes an element file and extracts a keyword (S1910). For example, a file uploaded by a user is analyzed using an artificial intelligence model, and important keywords related to content and assets may be extracted through a language model.

The recommendation apparatus transforms the extracted keywords into English (S1920). When the extracted keyword is languages other than English, the extracted Keyword may be transformed into English for accuracy of the language model included in the recommendation apparatus.

The recommendation apparatus transforms the keyword into the story type text through the language model (S1930). For example, the keyword transformed into English may be further decorated with a story type text using a language model template. The language model may serve to generate and structure sentences based on previously trained text data.

The recommendation apparatus transforms the story type text into the storyline that includes the background, main characters, and main elements (S1940).

For example, the recommendation apparatus may analyze the returned story by utilizing the language model again, and write the analyzed story as the storyline including the background, main characters, and main elements among those.

The recommendation apparatus transforms the storyline into the sentence data for the content generation and/or asset recommendation (S1950). For example, the recommendation apparatus may transform information such as the background, main characters, and main elements included in the story into the JSON type sentence data.

The recommendation apparatus updates meta information of an asset based on sentence data (S1960). For example, the recommendation apparatus may include the asset meta information. Through the meta information update, asset attributes, features, related information, etc., may be enriched, and used for search and classification of assets in the future.

For example, the platform may utilize the added meta information to increase the search range of assets. In more detail, users may search for and select a more accurate and desired asset by utilizing this meta information. Through this, users may quickly find necessary assets and improve efficiency in the content production process.

The aforementioned present disclosure may be implemented in a medium on which a program has been recorded as a computer-readable code. The computer-readable medium includes all types of recording media in which data readable by a computer system is stored. Examples of the computer-readable medium include a hard disk drive (HDD), a solid state disk (SDD), a silicon disk drive (SDD), ROM, RAM, CD-ROM, a magnetic tape, a floppy disk, an optical data storage device, and also include an implementation having the form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the components described in the embodiments may be modified and implemented. Furthermore, differences related to such modifications and applications should be construed as belonging to the scope of the present disclosure defined in the appended claims.

1. A method of generating, by a recommendation apparatus, content to a user and recommending an asset to be displayed in the content, the method comprising:
receiving a sentence for generating the content from a user;
transforming the sentence into a story type text through a language model;
transforming the story type text into a storyline including 1) a background, 2) a main character, and 3) a main element through the language model;
transforming the storyline into sentence data for generating the content or recommending the asset through the language model; and
generating the content or recommending the asset based on the sentence data.

2. The method of claim 1, further comprising:
transforming the sentence into English; and
transforming the storyline into Hangul.

3. The method of claim 2, wherein the sentence data includes a source word, an English word corresponding to the source word, parts of speech, and importance.

4. The method of claim 1, wherein the story type text is transformed through the language model based on a command for writing a synopsis.

5. The method of claim 3, further comprising:
extracting a keyword by analyzing an element file including element information;
transforming the keyword into the story type text through the language model; and
updating meta information of the asset based on the sentence data.

6. The method of claim 5, wherein the meta information of the asset is used to search for the asset.

7. A recommendation apparatus for recommending an asset and content to a user, comprising:
a communication unit;
a memory including a language model; and
a processor configured to functionally control the communication unit and the memory,
wherein the processor receives a sentence for generating the content from a user, transforms the sentence into a story type text through a language model, transforms the story type text into a storyline including 1) a background, 2) a main character, and 3) a main element through the language model, transforms the storyline into sentence data for generating the content or recommending the asset through the language model, and generates the content or recommending the asset based on the sentence data.
